(19) United States
(12) Patent Application Publication
(10) Pub. No.: US 2015/0072214 A1
(43) Pub. Date: Mar. 12, 2015

(54) USE FOR BINDER-RESIN COMPOSITION, RESIN COMPOSITION FOR TREATING SURFACE OF SUBSTRATE FOR SEPARATOR FOR NONAQUEOUS-ELECTROLYTE SECONDARY BATTERY, SEPARATOR FOR NONAQUEOUS-ELECTROLYTE BATTERY, METHOD FOR MANUFACTURING SAID SEPARATOR, AND NONAQUEOUS-ELECTROLYTE SECONDARY BATTERY

(71) Applicant: SUMITOMO CHEMICAL COMPANY, LIMITED, Chuo-ku, Tokyo (JP)

(72) Inventors: Junji Suzuki, Niihama-shi (JP); Hirohiko Hasegawa, Niihama-shi (JP); Chikae Yoshimaru, Osaka-shi (JP)

(73) Assignee: SUMITOMO CHEMICAL COMPANY, LIMITED, Chuo-ku, Tokyo (JP)

(21) Appl. No.: 14/391,186

(22) PCT Filed: Apr. 8, 2013
(86) PCT No.: PCT/JP2013/061134

§ 371 Date: Oct. 8, 2014

(30) Foreign Application Priority Data
Apr. 10, 2012 (JP) 2012-089045

(51) Int. Cl. H01M 2/16; H01M 2/14

(52) U.S. Cl. CPC H01M 2/1686; H01M 2/145; H01M 2/1653
USPC 429/144; 427/58; 524/35

(57) ABSTRACT

The present invention provides a binder-resin composition (a) for binding filler particles to a surface of a separator substrate for a nonaqueous-electrolyte secondary battery. The use of this composition makes it possible to give a separator excellent in heat resistance. The binder-resin composition (a) is a resin composition including a water-soluble polymer (A) having a metal carboxylate group, and a water-soluble polymer (B) having a hydroxyl group, a carboxyl group or a sulfo group. However, the composition does not include a copolymer C that includes a structural unit (1) derived from vinyl alcohol and a structural unit (2) derived from a metal salt of acrylic acid.

### TECHNICAL FIELD

The present invention relates to the use of a binder-resin composition for binding filler particles to a surface of a separator substrate for a nonaqueous-electrolyte secondary battery; a resin composition for treating a surface of a separator substrate for a nonaqueous-electrolyte secondary battery, this composition containing the binder-resin composition and filler particles; a separator for a nonaqueous-electrolyte secondary battery, this separator containing the binder-resin composition; a method for manufacturing the separator; and a nonaqueous-electrolyte secondary battery including the separator.

### BACKGROUND ART

Patent Document 1 states that polyvinyl alcohol is used as a binder for binding filler particles to a surface of a separator substrate for a nonaqueous-electrolyte secondary battery.

However, a separator obtained using, as this binder, polyvinyl alcohol cannot necessarily satisfy heat resistance. An object of the present invention is to provide a separator excellent in heat resistance.

### PRIOR ART DOCUMENT

### Patent Document

Patent Document 1: WO 2008/093575

### DISCLOSURE OF THE INVENTION

The present invention includes the inventions recited in the following items [1] to [22].

[1] Use of the following binder-resin composition (a) for binding filler particles to a surface of a separator substrate for a nonaqueous-electrolyte secondary battery:

binder-resin composition (a): a resin composition comprising a water-soluble polymer (A) having a metal carboxylate group, and a water-soluble polymer (B) having a hydroxyl group, a carboxyl group or a sulfo group;

wherein the following copolymer (C) is not comprised:

copolymer C: a copolymer comprising a structural unit (1) derived from vinyl alcohol, and a structural unit (2) derived from a metal salt of acrylic acid.

[2] The use, wherein the amount of the water-soluble polymer (A) contained in the binder-resin composition (a) is from 10 to 90 parts by volume for 100 parts by volume of the total of the water-soluble polymer (A) and the water-soluble polymer (B).
[3] The use, wherein the water-soluble polymer (A) is a metal salt of cellulose glycolic acid, or a metal salt of polyacrylic acid.
[4] The use, wherein the water-soluble polymer (B) is polyvinyl alcohol.
[5] A resin composition for treating a surface of a separator substrate for a nonaqueous-electrolyte secondary battery, comprising a water-soluble polymer (A) having a metal carboxylate group, a water-soluble polymer (B) having a hydroxyl group, a carboxyl group or a sulfo group, and filler particles;

wherein the following copolymer (C) is not comprised:

copolymer C: a copolymer comprising a structural unit (1) derived from vinyl alcohol, and a structural unit (2) derived from a metal salt of acrylic acid.

[6] The resin composition, wherein the amount of the water-soluble polymer (A) is from 10 to 90 parts by volume for parts by volume of the total of the water-soluble polymer (A) and the water-soluble polymer (B).
[7] The resin composition, wherein the amount of the filler particles is from 100 to 100000 parts by weight for 100 parts by weight of the total of the water-soluble polymer (A) and the water-soluble polymer (B).
[8] The resin composition, wherein the water-soluble polymer (A) is a metal salt of cellulose glycolic acid, or a metal salt of polyacrylic acid.
[9] The resin composition, wherein the water-soluble polymer (B) is polyvinyl alcohol.
[10] The resin composition, further comprising a solvent.
[11] A separator for a nonaqueous-electrolyte secondary battery, comprising: a filler layer comprising a water-soluble polymer (A) having a metal carboxylate group, a water-soluble polymer (B) having a hydroxyl group, a carboxyl group or a sulfo group, and filler particles; and a separator substrate for the nonaqueous-electrolyte secondary battery;

wherein the following copolymer (C) is not comprised:

copolymer C: a copolymer comprising a structural unit (1) derived from vinyl alcohol, and a structural unit (2) derived from a metal salt of acrylic acid.

[12] The separator, wherein the amount of the water-soluble polymer (A) is from 10 to 90 parts by volume for 100 parts by volume of the total of the water-soluble polymer (A) and the water-soluble polymer (B).
[13] The separator, wherein the amount of the filler particles is from 100 to 100000 parts by weight for 100 parts by weight of the total of the water-soluble polymer (A) and the water-soluble polymer (B).
[14] The separator, wherein the water-soluble polymer (A) is a metal salt of cellulose glycolic acid, or a metal salt of polyacrylic acid.
[15] The separator, wherein the water-soluble polymer (B) is polyvinyl alcohol.
[16] The separator, wherein the separator substrate for the nonaqueous-electrolyte secondary battery is a polyolefin porous membrane.
[17] The separator, wherein the filler particles are fine particles of an inorganic substance.
[18] The separator, wherein the inorganic substance is alumina.
[19] A method for manufacturing a separator for a nonaqueous-electrolyte secondary battery, comprising the step of applying the resin composition to a surface of a separator substrate.
[20] The manufacturing method, further including the step of drying the resultant applied product.
[21] The manufacturing method, wherein the separator substrate for the nonaqueous-electrolyte secondary battery is a polyolefin porous membrane.
[22] A nonaqueous-electrolyte secondary battery, comprising the separator.

When the binder-resin composition (a) is used to bind filler particles to a surface of a separator substrate for a nonaqueous-electrolyte secondary battery, a separator excellent in heat resistance is obtained. A nonaqueous-electrolyte secondary battery including this separator is excellent in safety. Moreover, the filler particles can be restrained from dropping out, so that the separator is easily handled.

Hereinafter, the present invention will be described in detail.

First, about the binder-resin composition (a), a description is made.

The binder-resin composition (a) contains: a water-soluble polymer (A) having a metal carboxylate group, and

a water-soluble polymer (B) having a hydroxyl group, a carboxyl group or a sulfo group.

However, the binder-resin composition (a) does not contain the following copolymer (C):

copolymer C: a copolymer including a structural unit (1) derived from vinyl alcohol, and a structural unit (2) derived from a metal salt of acrylic acid.

The “metal carboxylate group” in the water-soluble polymer (A) denotes a group comprising a carboxylate group (—CO₂—), and a metal cation. The metal cation is preferably an alkali metal cation or an alkaline earth metal cation. More preferred is an alkali metal cation. Further preferred is a lithium cation or a sodium cation (—CO₂Li or —CO₂Na as the metal carboxylate group).

The water-soluble polymer (A) is preferably a metal salt of cellulose glycolic acid, or a metal salt of polyacrylic acid, more preferably sodium cellulose glycolate.

The metal salt of cellulose glycolic acid may be a commercially available salt, or may be a salt produced by any known method. Sodium cellulose glycolate, out of metal salts of cellulose glycolic acid, is commercially available as carboxymethylcellulose (CMC). CMC species having various etherization degrees and molecular weights are usable.

The metal salt of polyacrylic acid may be a commercially available metal salt of polyacrylic acid that may have various molecular weights. The metal salt of polyacrylic acid may be a salt produced by any known method, for example, a method of neutralizing any commercially available polyacrylic acid with a metal hydroxide.

CMC and metal salts of polyacrylic acid are each a dispersion stabilizer for coating fluid. Thus, a coating fluid in which these substances are each used is excellent in storage stability to be suitable for being applied.

The water-soluble polymer (8) may be poly-vinyl alcohol, polyacrylic acid, or some other. The polyvinyl alcohol may be of commercially available species having various molecular weights and saponification degrees. The polyacrylic acid may be of commercially available species having various molecular weights. These polymers may each be of a species produced by any known method.

The amount of the water-soluble polymer (A) contained in the binder-resin composition (a) is preferably from 10 to 90 parts by volume, more preferably from 20 to 80 parts by volume for 100 parts by volume of the total of the water-soluble polymer (A) and the water-soluble polymer (B).

The binder-resin composition (a) may contain, besides the water-soluble polymers (A) and (B), any resin other than the copolymer (C). The content of this resin is preferably 20 parts or less by volume, more preferably 10 parts or less by volume, even more preferably 1 part or less by volume for 100 parts by volume of the total of the water-soluble polymers (A) and (B).

The binder-resin composition (a) can be produced by mixing the water-soluble polymers (A) and (B), and the resin to be optionally contained with each other.

The following will describe the use of the binder-resin composition (a) for binding filler particles to a surface of a separator substrate for a nonaqueous-electrolyte secondary battery.

Such a use is attained by, for example, a substrate-surface-treating method including the step of applying a resin composition including a binder-resin composition (a) and filler particles to a surface of a separator substrate for a nonaqueous-electrolyte secondary battery. Preferably, this surface-treating method further includes the step of drying the resultant applied product. Each of the steps of this surface-treating method is the same as each of steps of a method that will be described later for manufacturing a separator.

### <Resin Composition for Treating Surface of Separator Substrate for Nonaqueous-Electrolyte Secondary Battery (Also Referred to as “Surface-Treating Resin Composition” in the Present Specification)>

The surface-treating resin composition of the present invention contains:

a water-soluble polymer (A) having a metal carboxylate group,

a water-soluble polymer (B) having a hydroxyl group, a carboxyl group or a sulfo group, and

filler particles.

Preferably, this composition further contains a solvent.

However, this composition does not contain the above-mentioned copolymer (C).

The filler particles may be fine particles of an inorganic substance, or fine particles of an organic substrate. Examples of the inorganic substance fine particles include calcium carbonate, talc, clay, kaolin, silica, hydrotalcite, diatomaceous earth, magnesium carbonate, barium carbonate, calcium sulfate, magnesium sulfate, barium sulfate, aluminum hydroxide, magnesium hydroxide, calcium oxide, magnesium oxide, titanium oxide, alumina, mica, zeolite and glass. Examples of the organic substance fine particles include homopolymers each made from any one of the following or copolymers each made from two or more of the following: styrene, vinyl ketone, acrylonitrile, methyl methacrylate, ethyl methacrylate, glycidyl methacrylate, glycidyl acrylate, methyl acrylate, and others; fluororesins such as polytetrafluoroethylene, tetrafluoroethylene/hexafluoropropylene copolymer, tetrafluoroethylene/ethylene copolymer, and polyvinylidene fluoride; melamine resins; urea resins; polyethylenes; polypropylenes; and polymethacrylates. The filler particles may be a mixture of fine particles of two or more species, or a mixture of fine particles that are of the same species but have different particle size distributions. For the filler particles, preferred is alumina out of these species. The average particle size of the filler particles is preferably 3 m or less, more preferably 1 j m or less. The average particle size referred to herein is the average of the primary particle size thereof that is gained through SEM (scanning electron microscope) observation.

The use amount of the filler particles is preferably from 100 to 100000 parts by weight, more preferably from 1000 to 10000 parts by weight for 100 parts by weight of the total of the water-soluble polymers (A) and (B). If the use amount of the filler particles is too small, the resultant separator is lowered in gas permeability so that the degree of ion permeation therein may be unfavorably lowered to cause a battery to be lowered in load characteristic. If the use amount of the filler particles is too large, the resultant separator may be unfavorably declined in dimensional stability.

The solvent may be, for example, water or an oxygen-containing organic compound having a boiling point of 50 to 35000 under normal pressure. Specific examples of the oxygen-containing organic compound include compounds each having an alcoholic hydroxyl group, such as methanol, ethanol, n-propyl alcohol, isopropyl alcohol, n-butyl alcohol, isobutyl alcohol, s-butyl alcohol, amyl alcohol, isoamyl alcohol, methylisobutyl carbinol, 2-ethylbutanol, 2-ethylhexanol, cyclohexanol, furfuryl alcohol, tetrahydrofurfuryl alcohol, ethylene glycol, hexylene glycol and glycerin; saturated aliphatic ether compounds such as propyl ether, isopropyl ether, butyl ether, isobutyl ether, n-amyl ether, isoamyl ether, methyl butyl ether, methyl isobutyl ether, methyl n-amyl ether, methyl isoamyl ether, ethyl propyl ether, ethyl isopropyl ether, ethyl butyl ether, ethyl isobutyl ether, ethyl n-amyl ether, and ethyl, isoamyl ether; unsaturated aliphatic ether compounds such as allyl, ether and ethyl allyl ether; aromatic ether compounds such as anisole, phenetole, phenyl ether and benzyl ether; cyclic ether compounds such as tetrahydrofuran, tetrahydropyran and dioxane; ethylene glycol ether compounds such as ethylene glycol monomethyl ether, ethylene glycol monoethyl ether, ethylene glycol monobutyl ether, diethylene glycol monomethyl ether, diethylene glycol monoethyl ether, and diethylene glycol monobutyl ether; monocarboxylic acid compounds such as formic acid, acetic acid, acetic anhydride, acrylic acid, citric acid, propionic acid, and butyric acid; organic acid ester compounds such as butyl formate, amyl formate, propyl acetate, isopropyl acetate, butyl acetate, s-butyl acetate, amyl acetate, isoamyl acetate, 2-ethylhexyl acetate, cyclohexyl acetate, butylcyclohexyl acetate, ethyl propionate, butyl propionate, amyl propionate, butyl butyrate, diethyl carbonate, diethyl oxalate, methyl lactate, ethyl lactate, butyl lactate, and triethyl phosphate; ketone compounds such as acetone, ethyl ketone, propyl ketone, butyl ketone, methyl isopropyl ketone, methyl isobutyl ketone, diisobutyl ketone, acetylacetone, diacetone alcohol, cyclohexanone, cyclopentanone, methylcyclohexanone, and cycloheptanone; dicarboxylic acid compounds such as succinic acid, glutaric acid, adipic acid, undecanoic diacid, pyruvic acid, and citraconic acid; and other oxygen-containing organic compounds such as 1,4-dioxane, furfural, and N-methylpyrrolidone.

A solvent is usable in which water and an oxygen-containing organic compound are blended with each other. In this case, about the blend ratio between water and the oxygen-containing organic compound, the amount of the oxygen-containing organic compound is preferably from 0.1 to parts by weight, more preferably from 0.5 to 50 parts by weight, further preferably from 1 to 20 parts by weight for 1.00 parts by weight of water.

The use amount of the solvent is not particularly limited, and is sufficient to be such an amount that the resin composition can obtain the property of being easily appliable onto a polyolefin substrate that will be later described. The solvent is incorporated to set the amount thereof into a range of preferably from 100 to 100000 parts by weight, more preferably from 200 to 50000 parts by weight, further preferably from 300 to 30000 parts by weight, further more preferably from 500 to 20000 parts by weight for 100 parts by weight of the total of the water-soluble polymers (A) and (B).

The surface-treating resin composition of the present invention may contain a dispersing agent, a plasticizer, a surfactant, a pH adjustor, an inorganic salt, any resin other than the water-soluble polymers (A) and (B) and the copolymer (C), and others as far as the object of the invention is not damaged.

The surface-treating resin composition of the present invention may be manufactured by any method. Examples thereof include a method of mixing the filler particles and the water-soluble polymers (A) and (B) with each other, and then adding the solvent thereto; a method of mixing the filler particles with the solvent, and then adding the water-soluble polymers (A) and (B) thereto; a method of adding the filler particles, the water-soluble polymers (A) and (B), and the solvent simultaneously to be mixed with each other; and a method of mixing the water-soluble polymers (A) and (B) and the solvent with each other, and then adding the filler particles thereto. Of course, the resin composition may be manufactured by a method of mixing the water-soluble polymers (A) and (B) beforehand with each other to yield a binder-resin composition (a), and mixing this binder-resin composition (a) with the filler particles in the presence of the solvent.

### <Separator for Nonaqueous-Electrolyte Secondary Battery (Also Referred to as “Separator” in the Present Specification)>

The separator of the present invention includes: a filler layer including a water-soluble polymer (A), a water-soluble polymer (B) having a hydroxyl group, a carboxyl group or a sulfo group, and filler particles; and a separator substrate for a nonaqueous-electrolyte secondary battery (the separator substrate being also referred to as the “substrate” in the specification). Specifically, the separator is a laminated product including a layer including the water-soluble polymers (A) and (B), and filler particles (this layer being also referred to as the “filler layer” in the specification); and a layer of the substrate, preferably a laminated product made only of the substrate layer and the filler layer.

Examples of the substrate include a thermoplastic resin such as a polyolefin, paper obtained by papermaking from viscose rayon, natural cellulose or some other, mixed paper obtained by papermaking from fibers such as cellulose and polyester, electrolytic paper, craft paper, Manila paper, a Manila hemp sheet, glass fiber, porous polyester, aramid fiber, polybutylene terephthalate nonwoven fabric, para-type wholly aromatic polyamide, and an unwoven fabric or porous membrane made of a fluorine-contained resin such as vinylidene fluoride, tetrafluoroethylene, a copolymer made from vinylidene fluoride and hexafluoropropylene, or fluorine-contained rubber.

The substrate is preferably a porous membrane of a polyolefin, which preferably contains a high molecular weight component having a weight-average molecular weight of 5×10⁵ to 15×10⁶. Examples of the polyolefin include homopolymers or copolymers each made from, for example, ethylene, propylene, 1-butene, 4-methyl-1-pentene and/or 1-hexene. Of these polymers, preferred is a copolymer made mainly from ethylene, or a homopolymer made from ethylene. More preferred is a homopolymer made from ethylene, that is, polyethylene.

The porosity of the substrate is preferably from 30 to 80% by volume, more preferably from 40 to 70% by volume. If the porosity is less than 30% by volume, the substrate may become small in electrolyte-holding capacity. If the porosity is more than 80% by volume, the substrate or separator may insufficiently become poreless at high temperatures at which this member undergoes shutdown. The pore diameter is preferably 3 μm or less, more preferably 1 μm or less.

The thickness of the substrate is preferably from 5 to 50 μm, more preferably from 5 to 30 μm. If the thickness is less than 5 μm, the substrate or separator may insufficiently become poreless at high temperatures at which this member undergoes shutdown. If the thickness is more than 50 μm, the thickness of the whole of the separator of the present invention becomes large so that the resultant battery may become small in electrical capacity.

This substrate may be a commercially available product having the above-mentioned properties. The method for producing the substrate is not particularly limited, and may be any known method. The method is, for example, a method of adding a plasticizer into a thermoplastic resin, shaping the resultant into a film, and then removing the plasticizer with an appropriate solvent, as described in JP-A-07-29563, or a method of selectively drawing, about a film made of a thermoplastic resin, its amorphous regions which are structurally weak, to form fine pores, as described in JP-A-07-304110.

The thickness of the filler layer is preferably from 0.1 to 10 μm or less. If the thickness is less than 5 μm, the separator may insufficiently become poreless at high temperatures at which the separator undergoes shutdown. If the thickness is more than 10 μm, the resultant nonaqueous-electrolyte secondary battery may be lowered in load characteristic.

The separator of the present invention may contain, for example, an adhesive layer, a protective layer or any other porous membrane layer other than the substrate layer and the filler layer unless the performance of the resultant nonaqueous-electrolyte secondary battery is damaged.

The value of the gas permeability of the separator of the present invention is preferably from 50 to 2000 seconds/100 cc, more preferably from 50 to 1000 seconds/100 cc. As the value of the gas permeability is smaller, the resultant nonaqueous-electrolyte secondary battery is made better in load characteristic to be more preferred. However, if the value is less than 50 seconds/100 cc, the separator may insufficiently become poreless at high temperatures at which the separator undergoes shutdown. If the value of the gas permeability is more than 2000 seconds/100 cc, the resultant nonaqueous-electrolyte secondary battery may be lowered in load characteristic.

### <Method for Manufacturing Separator>

The method of the present invention for manufacturing a separator may be performed, for example, in a manner including the steps of: applying the surface-treating resin composition of the invention onto a support other than the above-defined substrate to yield a laminated product comprising the support and a filler layer; drying the resultant laminated product; separating the filler layer and the support from the dried laminated product; and bonding the resultant filler layer onto a substrate under pressure. Preferably, the manufacturing method is performed in a manner including the step of applying the surface-treating resin composition of the present invention onto a surface of a substrate to yield a laminated product comprising the substrate and a filler layer. More preferably, the manufacturing method further includes the step of drying the resultant laminated product. Before the applying of the surface-treating resin composition of the invention onto the surface of the substrate, the substrate may be beforehand subjected to corona treatment.

The method for applying the surface-treating resin composition of the invention onto the surface of the substrate, or the support other than the substrate may be performed through an industrially ordinarily performed manner, for example, a manner based on applying using a coater (also called a doctor blade), or on applying using a brush. The thickness of the filler layer can be controlled by adjusting the thickness of the applied membrane, the concentration of the water-soluble polymers (A) and (B) in the surface-treating resin composition, the quantity ratio between the filler particles, the water-soluble polymer (A) and the water-soluble polymer (B), and/or other factors. The support other than the substrate may be, for example, a film made of resin, or a belt or drum made of metal.

In the present invention, the wording “drying the laminated product” denotes that the solvent contained mainly in the filler layer of the laminated product (the solvent being also referred to as the “solvent (b)” hereinafter) is removed. The drying is attained by vaporizing the solvent (b) from the filler layer through, for example, a heating unit using a heating device such as a hot plate or a pressure-reducing unit using a pressure-reducing device, or a combination of these units. Conditions for the heating unit or pressure-reducing unit may be appropriately selected in accordance with the species of the solvent (b), and/or other factors as far as the substrate layer is not lowered in gas permeability. In the case of, for example, a hot plate, it is preferred to adjust the surface temperature of the hot plate to the melting point of the substrate layer, or lower. About the pressure-reducing unit, it is advisable to seal the laminated product into an appropriate pressure-reducing machine, and then adjust the pressure inside the pressure-reducing machine into the range of about 1 to 1.0×10⁵ Pa. Another method is also usable that makes use of a solvent which is soluble in the solvent (b) and does not dissolve the used resin (a) (this solvent being also referred to as the “solvent (c)” hereinafter). The filler layer of the laminated product is immersed in the solvent (c). Thus, the solvent (b) is substituted with the solvent (c) so that the resin (a) dissolved in the solvent (b) precipitates. Next, the solvent (c) is removed by drying.

### <Nonaqueous-Electrolyte Secondary Battery (Also Referred to as “Battery” Hereinafter)>

The battery of the present invention includes the separator of the present invention. The following will describe its constituents other than the separator of the invention, giving, as an example, a case where the battery of the invention is a lithium ion secondary battery. However, the constituents are not limited to these described elements.

Any lithium ion secondary battery is, for example, a battery including electrodes (positive electrode and negative electrode), an electrolyte, a separator and others, in which lithium is oxidized and reduced between the two electrodes of the positive and negative electrodes to store and discharge electrical energy.

### (Electrodes)

The electrodes are positive and negative electrodes for a secondary battery. The electrodes are each usually in a state that an electrode active material and an optional conductor are applied through a binder onto at least one surface of a current collector (preferably, both surfaces thereof).

The electrode active material is preferably an active material capable of occluding and emitting lithium ions. The electrode active material is classified into a positive electrode active material and a negative electrode active material.

The positive electrode active material is, for example, a metal multiple oxide, in particular, a metal multiple oxide containing lithium, and at least one or more of iron, cobalt, nickel, and manganese; and is preferably an active material containing LiₓMO₂ wherein M represents one or more transition metals, preferably at least one of Co, Mn or Ni; and 1.10>x>0.05, or Li₂M₂O₄ wherein M represents one or more transition metals, preferably Mn; and 1.10>x>0.05. Examples thereof include multiple oxides represented by LiCoO₂, LiNiO₂, LiₓNi_{y}Co_{(1-y)}O₂ wherein 1.10>x>0.05 and 1>y>0, and LiMn₂O₄, respectively.

Examples of the negative electrode active material include various silicon oxides (such as SiO₂), carbonaceous substances, and metal multiple oxides. Preferred examples thereof include carbonaceous substances, such as amorphous carbon, graphite, natural graphite, MCMB, pitch based carbon fiber, and polyacene; multiple metal oxides each represented by AₓM_{y}O_{z} wherein A represents Li; M represents at least one selected from Co, Ni, Al, Sn and Mn; O represents an oxygen atom; and x, y and z are numbers satisfying the following ranges, respectively: 1.10≧x≧0.05, 4.00≧y≧0.85, and 5.00≧z≧1.5; and other metal oxides.

Examples of the above-mentioned conductor include conductive carbons such as graphite, carbon black, acetylene black, Ketjen black, and activated carbon; graphite type conductors such as natural graphite, thermally expanded graphite, scaly graphite, and expanded graphite; carbon fibers such as vapor-phase-grown carbon fiber; fine metal particles or metal fiber made of aluminum, nickel, copper, silver, gold, platinum or some other metal; conductive metal oxides such as ruthenium oxide and titanium oxide; and conductive polymers such as polyaniline, polypyrrole, polythiophene, polyacetylene, and polyacene.

Preferred are carbon black, acetylene black, and Ketjen black since a small amount thereof makes an effective improvement of the electrodes in electroconductivity.

The content of the conductor is, for example, preferably from 0 to 50 parts by weight, more preferably from 0 to 30 parts by weight for 100 parts by weight of each of the electrode active materials.

The material of the current collector is, for example, a metal such as nickel, aluminum, titanium, copper, gold, silver, platinum, aluminum alloy or stainless steel; a product formed by plasma-spraying or arc-spraying nickel, aluminum, zinc, copper, tin or lead, or an alloy of two or more of these metals thermally onto a carbon material or an activated carbon fiber; a conductive film in which a conductor is dispersed in a rubber or a resin such as styrene/ethylene/butylene/styrene copolymer (SEBS); or some other.

The shape or form of the current collector is, for example, a foil piece, flat plate, mesh, net, lath, punched or embossed shape or form, or a combination of two or more thereof (for example, a mesh-form flat plate).

Irregularities may be formed in the surface of the current collector by etching treatment.

Examples of the above-mentioned binder include fluorine-contained polymers such as polyvinylidene fluoride; diene polymers such as polybutadiene, polyisoprene, isoprene/isobutylene copolymer, natural rubber, styrene/1,3-butadiene copolymer, styrene/isoprene copolymer, 1,3-butadiene/isoprene/acrylonitrile copolymer, styrene/1,3-butadiene/isoprene copolymer, 1,3-butadiene/acrylonitrile copolymer, styrene/acrylonitrile/1,3-butadiene/methyl methacrylate copolymer, styrene/acrylonitrile/1,3-butadiene/itaconic acid copolymer, styrene/acrylonitrile/1,3-butadiene/methyl methacrylate/fumaric acid copolymer, styrene/1,3-butadiene/itaconic acid/methyl methacrylate/acrylonitrile copolymer, acrylonitrile/1,3-butadiene/methacrylic acid/methyl methacrylate copolymer, styrene/1,3-butadiene/itaconic acid/methyl methacrylate/acrylonitrile copolymer, and styrene/acrylonitrile/1,3-butadiene/methyl methacrylate/fumaric acid copolymer; olefin based polymers such as ethylene/propylene copolymer, ethylene/propylene/diene copolymer, polystyrene, polyethylene, polypropylene, ethylene/vinyl acetate copolymer, ethylene based ionomer, polyvinyl alcohol, vinyl acetate polymer, ethylene/vinyl alcohol copolymer, chlorinated polyethylene, polyacrylonitrile, polyacrylic acid, polymethacrylic acid, and chlorosulfonated polyethylene; styrene based polymers such as styrene/ethylene/butadiene copolymer, styrene/butadiene/propylene copolymer, styrene/isoprene copolymer, styrene/n-butyl acrylate/itaconic acid/methyl methacrylate/acrylonitrile copolymer, and styrene/n-butyl acrylate/itaconic acid/methyl methacrylate/acrylonitrile copolymer; acrylate based polymers such as polymethyl methacrylate, polymethyl acrylate, polyethyl acrylate, polybutyl acrylate, acrylate/acrylonitrile copolymer, and 2-ethylhexyl acrylate/methyl acrylate/acrylic acid/methoxypolyethylene glycol monomethacrylate; polyamide or polyimide based polymers such as polyamide 6, polyamide 66, polyamide 11, polyamide 12, aromatic polyamide, and polyimide; ester based polymers such as polyethylene terephthalate, and polybutylene terephthalate; cellulose based polymers (and salts thereof, such as ammonium salts and alkali metal salts thereof) such as carboxymethylcellulose, carboxyethylcellulose, ethylcellulose, hydroxymethylcellulose, hydroxypropylcellulose, and carboxyethylmethylcellulose; styrene/butadiene block copolymer, styrene/butadiene/styrene block copolymer, styrene/ethylene/butylene/styrene block copolymer, styrene/isoprene block copolymer, styrene/ethylene/propylene/styrene block copolymer and other block copolymers, ethylene/vinyl chloride copolymer, and ethylene/vinyl acetate copolymer; methyl methacrylate polymer and other polymers.

### (Electrolyte)

The electrolyte used in the lithium ion secondary battery may be, for example, a nonaqueous electrolyte in which a lithium salt is dissolved in an organic solvent. The lithium salt may be one made of the following or a mixture of two or more of the following: LiCO₄, LiPF₆, LiAsF₆, LiSbF₆, LiBF₄, LiCF₃SO₃, LiN(SO₂CF₃), LiC(SO₂CF₃), Li₂B₁₀Cl₁₀, respective lithium salts of lower aliphatic carboxylic acids, and LiAlCl₄.

The lithium salt preferably includes, out of these salts, at least one selected from the group consisting of LiPF₆, LiAsF₆, LiSbF₆, LiBF₄, LiCF₃SO₃, LiN(CF₃SO₂), and LiC(CF₃SO₂)₃, each of which contains fluorine.

Examples of the organic solvent used in the electrolyte include carbonates such as propylene carbonate, ethylene carbonate, dimethyl carbonate, diethyl carbonate, ethylmethyl carbonate, 4-trifluoromethyl-1,3-dioxolane-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitriles such as acetonitrile, and butyronitrile; amides such as N,N-dimethylformamide, N,N-dimethylacetoamide; carbamates such as 3-methyl-2-oxazolidone; sulfur-containing compounds such as sulfolane, dimethylsulfoxide, and 1,3-propanesultone; and compounds each obtained by introducing a fluorine substituent into any one of these organic solvents. Usually, two or more of these solvents are used in a mixture form.

The shape or form of the battery of the present invention is not particularly limited. Examples thereof include a laminated form, a coin form, a cylindrical form and a prismatic form.

Hereinafter, the present invention will be described by way of working examples thereof; however, the invention is not limited to these examples.

About each of the working examples, comparative examples and reference examples that will be described below, individual physical properties of its separator were measured by the following methods:

(1.) Dimension retaining percentage: The separator was cut into a piece 5 cm square. At the center thereof, guide lines were drawn into a 4 cm square form, and then the piece was sandwiched between two pieces of paper. The workpiece was held in an oven of 150′C temperature for 1 hour, and then taken away. The dimensions of the square were measured to calculate the dimension retaining percentage thereof.

The method for calculating the dimension retaining percentage is as follows:

The length of any one of the guide lines in the machine direction (MD) before the heating: L1,

The length of any one of the guide lines in the transverse direction (TD) before the heating: W1,

The length of the guide line in the machine direction (MD) after the heating: L2, and

The length of the guide line in the transverse direction (TD) after the heating: W2;

The dimension retaining percentage (%) in the machine direction (MD)=L2/L1×100, and

The dimension retaining percentage (%) in the transverse direction (TD)=W2/W1×100.

(2) Gas permeability: The property was in accordance with JIS P8117.
(3) Powder dropping test: Rubbed powder dropping test

A measurement was made in a surface rubbing test using a fractional motion tester. A sheet product, Savina (registered trademark) Minimax (manufactured by KB Seiren, Ltd.), was fitted to a rubbing region (2 cm×2 cm) of the frictional motion tester. The product Savina (registered trademark) Minimax was brought into contact with the heat-resistant layer side of the above-mentioned laminated porous film under a load of 2 kg. At a speed of 45 rpm, the rubbing region was reciprocated 5 times to rub the film. From a change in the weight of the rubbed part of the film, the dropped rubbed-powder amount was analyzed.

### REFERENCE EXAMPLE 1

### Polyethylene Porous Membrane

Prepared was a substance composed of 70% by weight of an ultra high molecular weight polyethylene powder (340M, manufactured by Mitsui Chemicals, Inc.) and 30% by weight of a polyethylene wax having a weight-average molecular weight of 1000 (FNP-0115, manufactured by Nippon Seiro Co., Ltd.). The following were added to total 100 parts by weight of the ultra high molecular weight polyethylene and the polyethylene wax: 0.4 part by weight of an antioxidant (Irg 1010, manufactured by Ciba Specialty Chemicals); 0.1 part by weight of an antioxidant (P168, manufactured by Ciba Specialty Chemicals); and 1.3 parts by weight of sodium stearate. To the resultant composition was further added calcium carbonate having an average particle diameter of 0.1 μm (manufactured by Maruo Calcium Co., Ltd.) to give a volume of 38% of the total volume of the composition. These components were mixed with each other while kept in a powdery form, using a Henschel mixer. The mixture was then melt-kneaded in a biaxial kneader to prepare a polyolefin resin composition. The polyolefin resin composition was rolled between a pair of rolls having a surface temperature of 150° C. to produce a sheet. This sheet was immersed in an aqueous solution of hydrochloric acid (hydrochloric acid: 4 mol/L, and nonionic surfactant: 0.5% by weight) to remove calcium carbonate, and subsequently the sheet was drawn 6 times at 105° C. and then subjected to corona treatment at 50 W/(m²/minute) to yield a porous substrate film (thickness: 16.9 μm) which was a porous membrane made of polyethylene.

### EXAMPLE 1

Water was added to the following mixture to set a solid content by percentage therein to 23% by weight: a mixture of parts by weight of fine alumina particles (trade name “AKP 3000” manufactured by Sumitomo Chemical Co., Ltd.), 2 parts by weight of a carboxymethylcellulose (article number: 3H, manufactured by Dai-ichi Kogyo Seiyaku Co., Ltd.), 1 part by weight of a polyvinyl alcohol (Wako first class, manufactured by Wako Pure Chemical Industries, Ltd.; average polymerization degree: 3100 to 3900; and saponification degree: 86 to 90% by mole) (the amount of the carboxymethylcellulose (water-soluble polymer (A)) was 61 parts by volume for 100 parts by volume of the total of the carboxymethylcellulose (water-soluble polymer (A)) and the polyvinyl alcohol (water-soluble polymer (B)), and parts by weight of isopropyl alcohol. The resultant mixture was stirred and mixed in a homo-mixer. The resultant mixture was stirred and mixed in a high-pressure disperser (Gaulin type) to yield a composition of the present invention as a homogeneous slurry. A gravure coater was used to apply the composition evenly onto a single surface of the porous substrate film yielded in Reference Example 1. The resultant applied product was dried in a drier of 60° C. temperature to yield a separator for a nonaqueous-electrolyte secondary battery.

About the resultant separator, the thickness was 25.6 μm, the weight per unit area was 18.6 g/m (the porous substrate film: 6.9 g/m²; the mixture of the carboxymethylcellulose and the polyvinyl alcohol: 11.7 g/m²; and the alumina: 11.4 g/m²).

Its individual physical properties are as follows:

(1) Dimension retaining percentage: 98% in the MD direction, and 98 in the TD direction
(2) Gas permeability: 111 seconds/100 cc
(3) Dropped powder amount: 0.12 g/m²

### EXAMPLE 2

A separator for a nonaqueous-electrolyte secondary battery was yielded in the same way as in Example 1 except that the amount of the polyvinyl alcohol in Example 1 was changed to 2 parts by weight (the amount of the carboxymethylcellulose (water-soluble polymer (A)) was 50 parts by volume for 100 parts by volume of the total of the carboxymethylcellulose (water-soluble polymer (A)) and the polyvinyl alcohol (water-soluble polymer (B)).

### EXAMPLE 3

A separator for a nonaqueous-electrolyte secondary battery was yielded in the same way as in Example 1 except that the amount of the polyvinyl alcohol in Example 1 was changed to 4 parts by weight (the amount of the carboxymethylcellulose (water-soluble polymer (A)) was 28 parts by volume for 100 parts by volume of the total of the carboxymethylcellulose (water-soluble polymer (A)) and the polyvinyl alcohol (water-soluble polymer (B)).

### EXAMPLE 4

A separator for a nonaqueous-electrolyte secondary battery was yielded in the same way as in Example 1 except that the amount of the carboxymethylcellulose in Example 1 was changed to 3 parts by weight, and the amount of the polyvinyl alcohol therein was changed to 2 parts by weight (the amount of the carboxymethylcellulose (water-soluble polymer (A)) was parts by volume for 100 parts by volume of the total of the carboxymethylcellulose (water-soluble polymer (A)) and the polyvinyl alcohol (water-soluble polymer (B)).

### EXAMPLE 5

A separator for a nonaqueous-electrolyte secondary battery was yielded in the same way as in Example 1 except that the amount of the carboxymethylcellulose in Example 1 was changed to 3 parts by weight, and the amount of the polyvinyl alcohol therein was changed to 4 parts by weight (the amount of the carboxymethylcellulose (water-soluble polymer (A)) was parts by volume for 100 parts by volume of the total of the carboxymethylcellulose (water-soluble polymer (A)) and the polyvinyl alcohol (water-soluble polymer (B)).

### COMPARATIVE EXAMPLE 1

A separator for a nonaqueous-electrolyte secondary battery was yielded in the same way as in Example 1 except that parts by weight of the polyvinyl alcohol was used instead of the 2 parts by weight of the carboxymethylcellulose and the 1 part by weight of the polyvinyl alcohol in Example 1.

### COMPARATIVE EXAMPLE 2

A separator for a nonaqueous-electrolyte secondary battery was yielded in the same way as in Example 1 except that parts by weight of the carboxymethylcellulose was used instead of the 2 parts by weight of the carboxymethylcellulose and the part by weight of the polyvinyl alcohol in Example 1.

In Table 1 are shown physical properties of the separator yielded in each of Examples 1 to 5 and Comparative Examples 1 and 2.

TABLE 1

| | | | | | Dimension | | Dropped |
|---|---|---|---|---|---|---|---|
| | | | | | retaining | | rubbed- |
| | Water-soluble | | Parts(s) | | percentage (%) | | powder |
| | polymers | | by weight | | MD | TD | amount |
| | A | B | A | B | direction | direction | [g/m²] |
| Example 1 | CMC | PVA | 2 | 1 | 98% | 98% | 0.12 |
| Example 2 | CMC | PVA | 2 | 2 | 98% | 98% | 0.00 |
| Example 3 | CMC | PVA | 2 | 4 | 99% | 99% | 0.00 |
| Example 4 | CMC | PVA | 3 | 2 | 98% | 98% | 0.15 |
| Example 5 | CMC | PVA | 3 | 4 | 99% | 99% | 0.00 |
| Comparative | CMC | PVA | 0 | 3 | 30% | 46% | 1.26 |
| Example 1 | CMC | PVA | | | | | |
| Comparative | CMC | PVA | 3 | 0 | 95% | 93% | 1.81 |
| Example 2 | CMC | PVA | | | | | |

CMC: Carboxymethylcellulose
PVA: Polyvinyl alcohol

It can be mentioned that as a separator is higher in dimension retaining percentage, the separator is better in heat resistance. It can also be mentioned that as a separator is smaller in dropped powder amount, the separator is easier to handle.

### INDUSTRIAL APPLICABILITY

When the above-mentioned binder-resin composition (a) is used to bind filler particles to a surface of a separator substrate for a nonaqueous-electrolyte secondary battery, a separator excellent in heat resistance can be obtained. A nonaqueous-electrolyte secondary battery including this separator is excellent in safety. Moreover, the separator is easy to handle since the filler particles can be restrained from dropping out therefrom.

1. Use of the following binder-resin composition (a) for binding filler particles to a surface of a separator substrate for a nonaqueous-electrolyte secondary battery:
binder-resin composition (a): a resin composition comprising a water-soluble polymer (A) having a metal carboxylate group, and a water-soluble polymer (B) having a hydroxyl group, a carboxyl group or a sulfo group;
wherein the following copolymer (C) is not comprised:
copolymer C: a copolymer comprising a structural unit (1) derived from vinyl alcohol, and a structural unit (2) derived from a metal salt of acrylic acid.

2. The use according to claim 1, wherein the amount of the water-soluble polymer (A) contained in the binder-resin composition (a) is from 10 to 90 parts by volume for parts by volume of the total of the water-soluble polymer (A) and the water-soluble polymer (B).

3. The use according to claim 1, wherein the water-soluble polymer (A) is a metal salt of cellulose glycolic acid, or a metal salt of polyacrylic acid.

4. The use according to claim 1, wherein the water-soluble polymer (B) is polyvinyl alcohol.

5. A resin composition for treating a surface of a separator substrate for a nonaqueous-electrolyte secondary battery, comprising a water-soluble polymer (A) having a metal carboxylate group, a water-soluble polymer (B) having a hydroxyl group, a carboxyl group or a sulfo group, and filler particles;
wherein the following copolymer (C) is not comprised:
copolymer C: a copolymer comprising a structural unit (1) derived from vinyl alcohol, and a structural unit (2) derived from a metal salt of acrylic acid.

6. The resin composition according to claim 5, wherein the amount of the water-soluble polymer (A) is from 10 to 90 parts by volume for 100 parts by volume of the total of the water-soluble polymer (A) and the water-soluble polymer (B).

7. The resin composition according to claim 5, wherein the amount of the filler particles is from 100 to 100000 parts by weight for 100 parts by weight of the total of the water-soluble polymer (A) and the water-soluble polymer (B).

8. The resin composition according to claim 5, wherein the water-soluble polymer (A) is a metal salt of cellulose glycolic acid, or a metal salt of polyacrylic acid.

9. The resin composition according to claim 5, wherein the water-soluble polymer (B) is polyvinyl alcohol.

10. The resin composition according to claim 5, further comprising a solvent.

11. A separator for a nonaqueous-electrolyte secondary battery, comprising: a filler layer comprising a water-soluble polymer (A) having a metal carboxylate group, a water-soluble polymer (B) having a hydroxyl group, a carboxyl group or a sulfo group, and filler particles; and a separator substrate for the nonaqueous-electrolyte secondary battery;
wherein the following copolymer (C) is not comprised:
copolymer C: a copolymer comprising a structural unit (1) derived from vinyl alcohol, and a structural unit (2) derived from a metal salt of acrylic acid.

12. The separator according to claim 11, wherein the amount of the water-soluble polymer (A) is from 10 to 90 parts by volume for 100 parts by volume of the total of the water-soluble polymer (A) and the water-soluble polymer (B).

13. The separator according to claim 11, wherein the amount of the filler particles is from 100 to 100000 parts by weight for 100 parts by weight of the total of the water-soluble polymer (A) and the water-soluble polymer (B).

14. The separator according to claim 11, wherein the water-soluble polymer (A) is a metal salt of cellulose glycolic acid, or a metal salt of polyacrylic acid.

15. The separator according to claim 11, wherein the water-soluble polymer (B) is polyvinyl alcohol.

16. The separator according to claim 11, wherein the separator substrate for the nonaqueous-electrolyte secondary battery is a polyolefin porous membrane.

17. The separator according to claim 11, wherein the filler particles are fine particles of an inorganic substance.

18. The separator according to claim 17, wherein the inorganic substance is alumina.

19. A method for manufacturing a separator for a nonaqueous-electrolyte secondary battery, comprising the step of applying the resin composition according to claim 5 to a surface of a separator substrate.

20. The manufacturing method according to claim 19, further comprising the step of drying the resultant applied product.

21. The manufacturing method according to claim 19, wherein the separator substrate for the nonaqueous-electrolyte secondary battery is a polyolefin porous membrane.

22. A nonaqueous-electrolyte secondary battery, comprising the separator according to claim 11.
